(19) United States
(12) Patent Application Publication
(10) Pub. No.: US 2006/0066628 A1
(43) Pub. Date: Mar. 30, 2006

(54) System and method for controlling dynamically interactive parameters for image processing

(75) Inventors: Alexander S. Brodie, Redmond, WA (US); David R. Parlin, Redmond, WA (US); Douglas A. Ricard, Woodinville, WA (US); Karthik G. Anbalagan, Bellevue, WA (US)

Correspondence Address: SHOOK, HARDY & BACON L.L.P.;(c/o MICROSOFT CORPORTATION), 2555 GRAND BOULEVARD, KANSAS CITY, MO, 64108-2613, US

(73) Assignee: Microsoft Corporation, Redmond, WA (US)

(21) Appl. No.: 10/953,188

(22) Filed: Sep. 30, 2004

(51) Int. Cl. G09G 5/02

(52) U.S. Cl. 345/594; 345/593

(57) ABSTRACT

A system and related techniques generate and present a set of linked, dynamically interactive image processing controls for image editing and optimization tasks. In embodiments a user interface may present a set of global editing modes such as color manipulation, exposure correction or others. Each mode may contain a hierarchical set of basic, intermediate and advanced controls such as one-button automatic fixes, color or saturation sliders or editable histograms or other curves. When a user wishes, for instance, to achieve a warmer color balance or perform other color-correction tasks, the system may automatically detect adjustments in one or more parameters, such as CMYK values, and automatically adjust the values of other parameters to enhance the intended correction or action. For instance when the magenta content on a CMYK slider is increased, the color saturation may be slightly increased or color temperature may be slightly raised, to create a warmer appearance in the color cast of the image. Other combinations of image parameters may be linked. According to embodiments, a set of editable curves such as histograms or gamma curves may be dragged or otherwise adjusted or manipulated by users, and saved for re-application to other images or at other times.

### CROSS-REFERENCE TO RELATED APPLICATION

Not applicable.

### STATEMENT REGARDING FEDERALLY SPONSORED RESEARCH OR DEVELOPMENT

Not applicable.

### FIELD OF THE INVENTION

The invention relates to the field of computer programming, and more particularly to systems and techniques for implementing image processing and other functions including grouped parametric controls, such as global color and exposure controls, which dynamically readjust constituent parameters to optimize the user's image editing activity.

### BACKGROUND OF THE INVENTION

The field of graphics processing applications, including image processing packages, has broadened and matured to a point where many image processing programs and tools permit a user to selectively adjust an array of image characteristics. Broadly speaking, many of those image editing tasks revolve around altering the color composition of a digital photograph or other image, or the exposure or lighting characteristics of the subject image or file. Within each category of task, commercially available programs typically offer the user a number of tools which can be activated by sliders, graphs or other interface objects. For instance, image processing packages exist which permit a user to change the relative amounts of red, green or blue (RGB) components or cyan, magenta, yellow or black (CMYK) component color in the pixels of an image, for instance by sliding those buttons to the left or right. Often the user may be presented with a preview pane in the interface depicting the image with the adjustment made, to decide if they wish to make that adjustment, or make that adjustment permanent.

However, manipulating independent sets of color, exposure or other image processing controls poses some difficulties or compromises. For one, when one control after another is independently activated, each action may involve processing which incurs floating-point rounding or other error as part of the necessary computations on pixel or other values. When a sequence of image editing operations using different tools is carried out independently, those rounding or other errors may accumulate or compounds themselves, leading to image degradation or inaccuracy. Moreover, performing a sequence of tasks to achieve a desired overall global effect on an image may require that the user learn an extensive set of skills in that particular application, remember the sequence which they have performed and be able to informally visualize the results of the next step or editing option. Users may not therefore be able to be as productive in carrying out those time-consuming manual tasks, and the results may still not conform to the user's intended editing objectives. Other problems in graphics processing and interface technology exist.

### SUMMARY OF THE INVENTION

The invention overcoming these and other problems in the art relates in one regard to a system and method for controlling dynamically interactive parameters for image processing, in which image processing functions may be categorized into global tasks including color editing or correction, exposure editing or correction or other functions or tasks. In embodiments, each global task may be broken down into a hierarchy of associated tools or functions, in embodiments starting with basic or one-button correction actions and descending to advanced histograms or other editable graphs or functions. According to embodiments of the invention in one regard, the parameters involved at each level in the editing hierarchy may be adjustable, but adjustable not merely independently but instead, in a linked fashion so that adjustments made to one parameter may automatically generate adjustments to one or more other parameters to achieve improved results. By grouping some or all associated tools under their respective global tasks, the interface to the user may be simplified, made more efficient and easier to use, and likewise lead to better image editing results since compensating enhancements may be automatically be made to related parameters, transparently to the user. Rounding and other errors that result from successive editing steps may also be reduced or eliminated, and customized editable curves may be saved as settings for repeated use.

### BRIEF DESCRIPTION OF THE DRAWINGS

FIG. 1 illustrates an environment in which a system and method for controlling dynamically interactive parameters for image processing may operate, according to embodiments of the invention.

FIG. 2 illustrates a color editing interface, according to embodiments of the invention.

FIG. 3 illustrates a color editing interface including a variety of levels of controls, according to embodiments of the invention.

FIG. 4 illustrates a color editing interface including color balance controls and a set of editable curves, according to embodiments of the invention.

FIG. 5 illustrates a color editing interface including color balance controls and a set of editable curves in another regard, according to embodiments of the invention.

FIG. 6 illustrates a set of color controls and additive adjustment interaction, according to embodiments of the invention.

FIG. 7 illustrates a color editing interface including a curve editing action, according to embodiments of the invention.

FIG. 8 illustrates a flowchart of overall interactive image processing, according to embodiments of the invention.

### DETAILED DESCRIPTION OF EMBODIMENTS

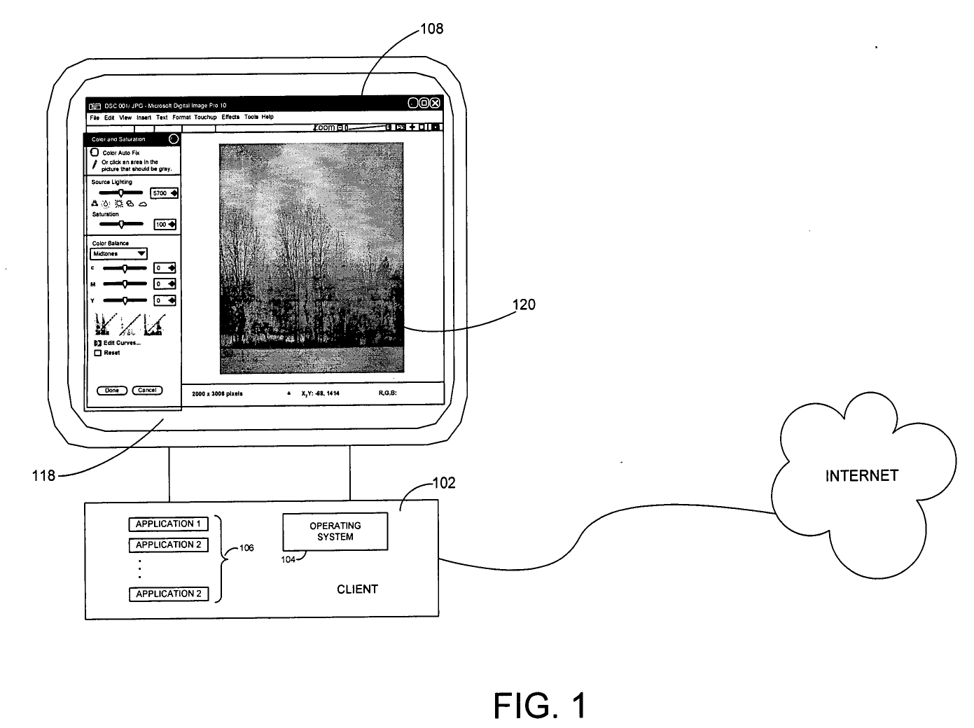

FIG. 1 illustrates an architecture in which a system and method for controlling dynamically interactive parameters for image processing may operate, according to an embodiment of the invention. As illustrated in that figure, a user may operate a client 102 using a user interface 118, such as a graphical user interface, under control of an operating system 104 such as the Microsoft Windows™ family of operating systems, or others. The client 102 may contain or host an installed or downloaded set of applications 106, such as word processing, Web browsing, or with regard to aspects of the invention, an image processing application 108. Client 102 so equipped and configured may be or include, for example, a personal computer, a workstation, a personal digital assistant, a network-equipped cellular phone or other device, machine or client. Client 102 may in embodiments as illustrated be configured with Internet or other network connectivity, or in other embodiments may be configured or operate in a stand-alone or non-networked mode.

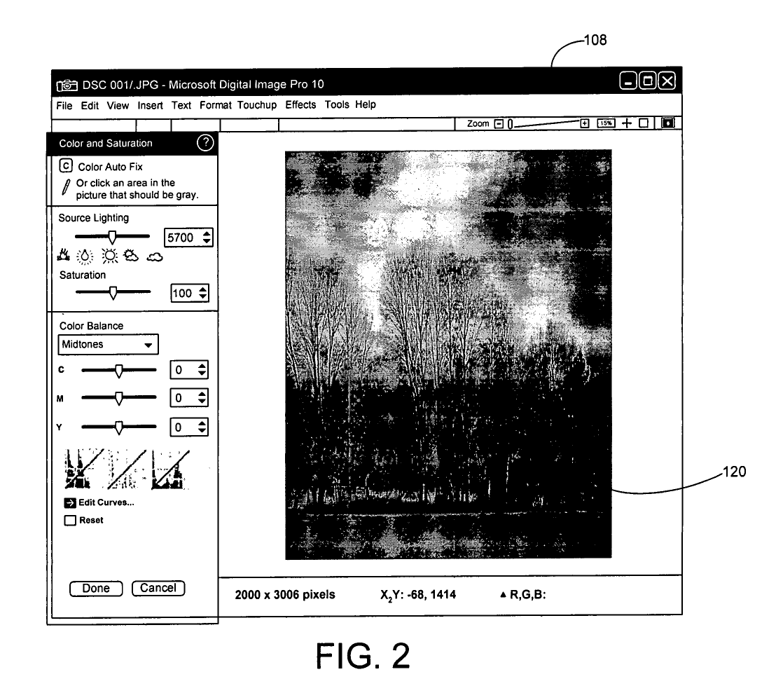

According to embodiments of the invention in one regard, and as further illustrated for example in FIG. 2, the user may invoke the image processing application 108 to open a digital photograph or other image 120 or other file or content to perform editing and image manipulation tasks. Those tasks may include for example opening an image, rotating an image, resizing an image, printing an image, emailing an image or performing other functions or tasks. More particularly, according to embodiments of the invention the user may choose to operate image processing application 108 to manipulate the content and composition of the image 120, to improve or edit the quality or appearance of that image. Image 120 may be or include, for example, digital photographs or other images or content, for instance stored in joint photographic experts group (.JPG), tagged image file format (.TIFF), graphics interchange format (.GIF), bit map (.BMP), or other files or formats.

According to embodiments of the invention, the image editing functions presented in image processing application 108 may be grouped into a set of global image processing tasks. Those comparatively high-level modes or activities may include, for example, a first set of color correction or editing functions, a second set of exposure correction or editing functions, or other global tasks. The modal user dialogues and other tools shown in FIG. 2 illustrated, for example, a corresponding set of color editing functions as a global task.

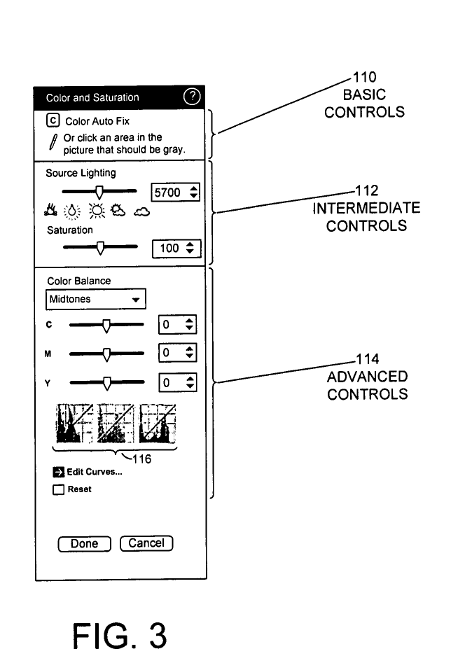

As illustrated in FIG. 3, the set of global color editing tasks may be broken down or presented as a hierarchy of selectable tools or controls. As shown in that figure, that hierarchy of controls may be or include, for example, basic controls 110, intermediate controls 112 and advanced controls 114. Other hierarchies, levels or groupings are possible. In embodiments as illustratively shown, basic controls 110 may be or include, for instance, a color automatic fix button or other one-click or other correction option, as well as, for instance, a gray-color eyedropper tool to alter the color composition of sections of image 120 to gray-scale or other grayed color casts. Other buttons, controls and variables for the basic level are possible.

Intermediate controls 112 as illustrated may be or include, for example, a set of slider buttons or bars to adjust image parameters such as the color temperature or other characteristics of source lighting, as well as color saturation of the overall image 120. Other buttons, controls and variables for the intermediate level are possible. Advanced controls 114 as illustrated may be or include, for example, a set of slider buttons for color components such as cyan, magenta, yellow, black (CMYK), red, green, blue (RGB) or other variables. Other buttons, controls and variables for the advanced level are possible, such as a set of editable curves 116 such as color or other histograms, gamma correction curves, or other curves or functions, which may in embodiments include selectable or moveable curve lines, as shown. Further variables which may be presented at the intermediate, advanced or other levels may include for instance hue controls, red-eye controls, color bit depth controls and white-balance controls. Similarly configured hierarchical sets of controls are possible, for example, for other global image processing tasks or modes such as for exposure correction, or others as discussed below.

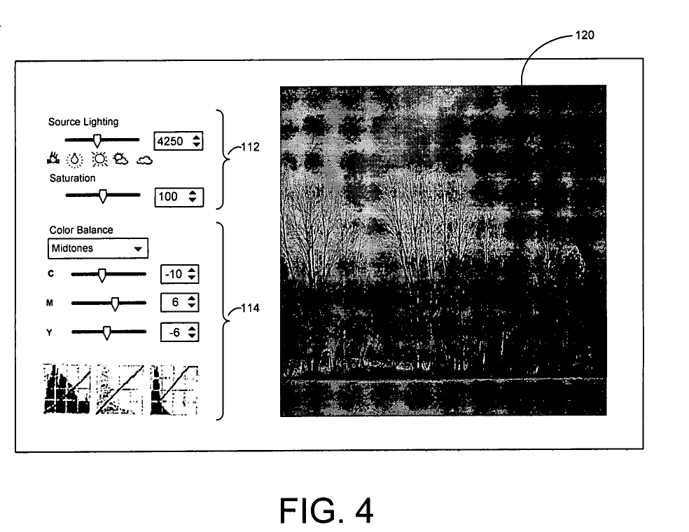

According to embodiments of the invention in a further regard, and as for example illustrated in FIG. 4, when individual controls or image processing parameters are manipulated at any one or more of the levels of the hierarchy of controls presented in image processing application 108, a coordinated or linked adjustment of other associated variables may automatically take place. That is, and as for example shown in FIG. 4, when a user manipulates an auto-fix or one-click option in basic controls 110 to correct or adjust for instance overall color in image 120, the image processing application 108 may automatically analyze image 120 and correct the color content of that image based on one or more parameters. In embodiments the image processing application 108 may, for example, respond to the user's auto-fix selection by detecting a color temperate of image 120, and determine for instance that the color temperature of the image 120 is warm and incandescent, which might translate for example to a color temperate of approximately 2500-2900 degrees Kelvin or other ranges.

The image processing application 108 may in response to that detected color temperature value or range automatically move or adjust a source lighting slider, acting as a color temperature control, in intermediate controls 112 to the left towards the light bulb icon, to adjust the presented color temperature range of image 120 on user interface 118. Sequentially or simultaneously, the image processing application 108 may automatically adjust the color balance sliders such as controls representing cyan, magenta and yellow (CMY, black optional but not shown) components to remove a degree of red color (−10), add a degree of green color (+6) and remove a degree of blue color (−6), as shown. Other combinations and adjustments are possible, in linked or parametric fashion.

According to embodiments of the invention in a further regard, and as likewise illustrated in FIG. 4, when color content or other automatic or compensating adjustments are made, those changes may be automatically and immediately reflected in the action of intermediate controls 112 and advanced controls 114, including to show deformation or alteration in the set of editable curves 116 depending on changes in color parameters.

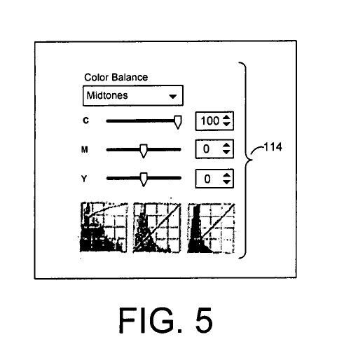

It may be noted that according to embodiments of the invention in another regard, when a user elects to make manual changes to individual variables such as by sliding individual slider bars or otherwise, that automatic corresponding changes to other sliders, controls, the set of editable controls 116 or other interface elements may also be automatically presented to the user. Thus, and for example as illustrated in FIG. 5, when one or more color component (CMY or other) sliders for example within intermediate controls 112 are moved by the user, the set of editable curves 116, such as a color histogram or other curve or function, may be automatically updated and presented to the user, in on-the-fly fashion.

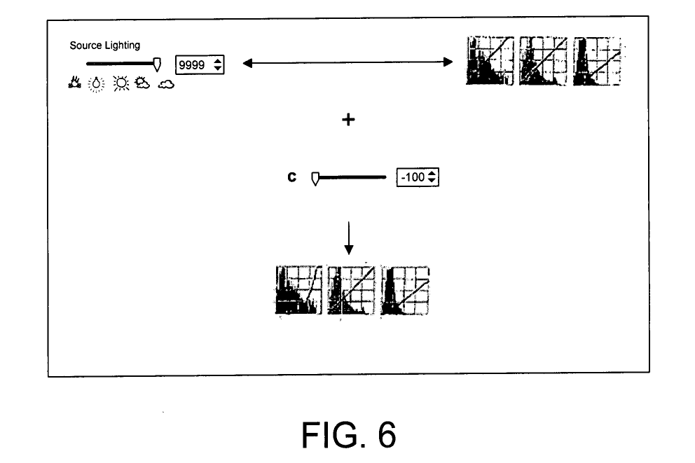

According to the interactivity aspect of the invention in another regard, and as illustrated FIG. 6, the interactive linkage or coupling between any two or more image parameters may in embodiments be employed to be additive. That is, as shown, an adjustment to source lighting in intermediate controls 112 may cause an dynamically interactive, automatic alteration to the set of editable curves 116. In the event that action is followed by an adjustment to a color slider (cyan as illustrated) in advanced controls 114, that action may similarly result in a dynamic or automatic further adjustment to the histograms or other curves or functions in the set of editable curves 116. Other combinations, sequences and resulting parametric adjustments are possible.

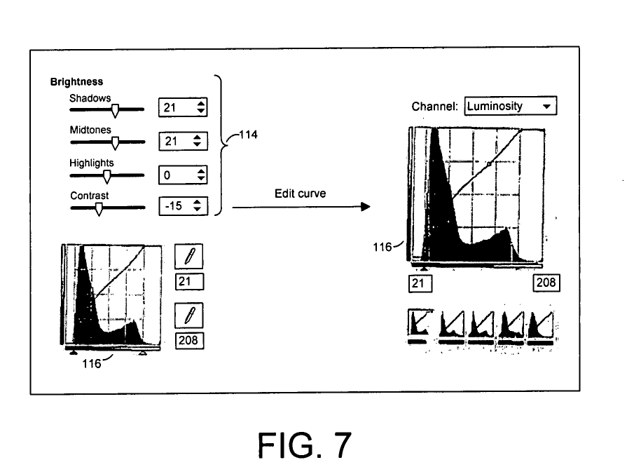

It may be noted again, and as illustrated in FIG. 7, that the set of global image processing tasks may include other high-order task groupings or modes, besides color modification itself. As illustrated in that figure, those other global modes may include global exposure editing or correction. That mode may include a set of hierarchical controls including basic controls (not shown, but which may for example include one-button exposure controls), intermediate controls (not shown, but which may for example include luminance slider bars) as well as advanced controls 114, which may include a set of editable curves 116 and other advanced controls, to manipulate the exposure quality of image 120. Other exposure hierarchies, controls and variables are possible, such as low-light compensation controls, backlight controls and gain controls. Other global image processing task-oriented modes, in embodiments, are likewise possible.

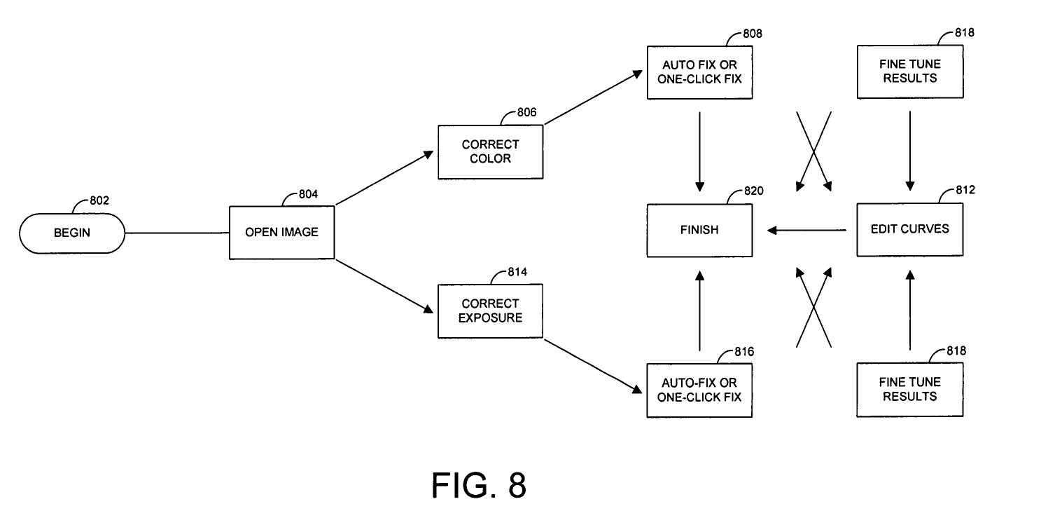

FIG. 8 illustrates overall processing of dynamically interactive controls, according to embodiments of the invention. In step 802, processing may begin. In step 804, an image file or other image source may be opened or accessed by image processing application 108 or other application or resource, to open an image 120 or other content. In step 806, a user may select an option to correct, for example, the color composition of the subject image 120. In step 808, the user may select for instance to activate an automatic fix, or one-click color correction option, for instance by clicking a button in or otherwise using basic controls 110. If the user elects to activate an automatic fix, the image processing application 108 may apply default, selected or calculated adjustments to color content, for instance to bring color temperature in line with typical indoor lighting, reduce saturation or otherwise manipulate the subject image 120 or other file or content. According to embodiments, those composite adjustments may be made transparently to the user, and may include dynamically interactive parameters in the execution of that automatic adjustment. Following step 808, if the image editing results are satisfactory processing may proceed to step 820 where editing may finish and processing may repeat, return to a prior processing point, jump to a further processing point or end.

If after any automatic adjustments made in step 808 the user wishes to continue editing, in step 810 the user may elect to fine-tune the results of the automatic image adjustment, for example by operating slider bars or other tools or resources of intermediate controls 112 or otherwise to adjust relative amounts of cyan, magenta, yellow or black (CMYK) or make other adjustments or modifications. Those fine tuning adjustments may themselves include dynamically interactive adjustments between active parameters. In step 812, the user may further manipulate advanced controls 114, such as the set of editable curves 116 which may include, for example, histogram, gamma curves or other curves or functions. The manipulation of editable curves 116 may also involve automatic interaction between color parameters. Following step 812, processing may process to step 820 where editing may finish and processing may repeat, return to a prior processing point, jump to a further processing point or end.

Following step 804, in step 814 the user may likewise choose to activate a set of exposure correction resources or tools, instead of, before or after applying any color correction or editing tools or steps. In step 816, the user may select or activate an automatic or one-click type of correction option for exposure purposes, for example by activating a one-click button in basic controls 110 or otherwise. The automated exposure adjustments may in one regard be dynamically interactive. In step 818, the corrected exposure results may be fine-tuned or adjusted, for example by manipulating slider controls or other activatable objects or controls in intermediate controls 112 such as brightness or exposure tools, or otherwise. Such intermediate adjustments may be likewise dynamically interactive, depending on the tools or parameters being adjusted or controlled. In step 812, the user may likewise manipulate a set of editable curves 116, for instance within advanced tools 114, to alter exposure parameters, which parameters may similarly be dynamically interactive or linked. Processing may then proceed to step 820 where editing may finish and processing may repeat, return to a prior processing point, jump to a further processing point or end

The foregoing description of the invention is illustrative, and modifications in configuration and implementation will occur to persons skilled in the art. For instance, while the invention has generally been described in terms of a set of dynamically interactive controls implemented in an image processing application 108, in embodiments similar controls or groupings of controls may be implemented or embedded in other applications or platforms, such as video processing applications, publishing applications, integrated applications or suites, or other applications or platforms.

Similarly, while the invention has in embodiments been generally described as assimilating color editing functions and exposure editing functions as two broad classes of functionality in which parametric groupings may be vertically incorporated, in embodiments other categories or types of functions may be used. Other hardware, software or other resources described as singular may in embodiments be distributed, and similarly in embodiments resources described as distributed may be combined. The scope of the invention is accordingly intended to be limited only by the following claims.

We claim:

1. A system for adjusting graphic editing controls using dynamically interactive parameters, comprising:
a user interface, the user interface presenting a set of grouped editing controls having dynamically interactive image parameters; and
an image processing engine, the image processing engine communicating with the user interface to receive user input and automatically parametrically adjusting at least two of the image parameters based on the user input.

2. A system according to claim 1, wherein the set of grouped editing controls comprises at least one of color editing controls and exposure editing controls.

3. A system according to claim 1, wherein the user interface comprises a graphical user interface.

4. A system according to claim 3, wherein the set of grouped editing controls comprises a set of hierarchical task controls.

5. A system according to claim 4, wherein the set of hierarchical task controls comprises at least basic controls, intermediate controls and advanced controls.

6. A system according to claim 5, wherein the basic controls comprise at least an automatic correction selector.

7. A system according to claim 5, wherein the intermediate controls comprise at least a set of slider bars.

8. A system according to claim 5, wherein the advanced controls comprise at least a set of editable curves.

9. A system according to claim 2, wherein the set of grouped editing controls comprises color editing controls, the color editing controls comprising at least one of color balance controls, saturation controls, hue controls, red-eye controls, color bit depth controls and white-balance controls.

10. A system according to claim 2, wherein the set of grouped editing controls comprises exposure editing controls, the exposure editing controls comprising at least one of low-light compensation controls, backlight controls and gain controls.

11. A system according to claim 1, wherein the image processing engine stores the automatically adjusted image parameters as a retrievable setting.

12. A method for adjusting graphic editing controls using dynamically interactive parameters, comprising:
presenting a set of grouped editing controls having dynamically interactive image parameters via a user interface; and
receiving user input from the user interface and automatically parametrically adjusting at least two of the image parameters based on the user input.

13. A method according to claim 12, wherein the set of grouped editing controls comprises at least one of color editing controls and exposure editing controls.

14. A method according to claim 12, wherein the user interface comprises a graphical user interface.

15. A method according to claim 14, wherein the set of grouped editing controls comprises a set of hierarchical task controls.

16. A method according to claim 15, wherein the set of hierarchical task controls comprises at least basic controls, intermediate controls and advanced controls.

17. A method according to claim 16, wherein the basic controls comprise at least an automatic correction selector.

18. A method according to claim 16, wherein the intermediate controls comprise at least a set of slider bars.

19. A method according to claim 16, wherein the advanced controls comprise at least a set of editable curves.

20. A method according to claim 13, wherein the set of grouped editing controls comprises color editing controls, the color editing controls comprising at least one of color balance controls, saturation controls, hue controls, red-eye controls, color bit depth controls and white-balance controls.

21. A method according to claim 13, wherein the set of grouped editing controls comprises exposure editing controls, the exposure editing controls comprising at least one of low-light compensation controls, backlight controls and gain controls.

22. A method according to claim 12, further comprising a step of storing the automatically adjusted image parameters as a retrievable setting.

23. An edited image, the edited image being generated via a method for adjusting graphic editing controls using dynamically interactive parameters, the method comprising:
presenting a set of grouped editing controls having dynamically interactive image parameters via a user interface; and
receiving user input from the user interface and automatically parametrically adjusting at least two of the image parameters based on the user input.

24. An edited image according to claim 23, wherein the set of grouped editing controls comprises at least one of color editing controls and exposure editing controls.

25. An edited image according to claim 23, wherein the user interface comprises a graphical user interface.

26. An edited image according to claim 25, wherein the set of grouped editing controls comprises a set of hierarchical task controls.

27. An edited image according to claim 26, wherein the set of hierarchical task controls comprises at least basic controls, intermediate controls and advanced controls.

28. An edited image according to claim 27, wherein the basic controls comprise at least an automatic correction selector.

29. An edited image according to claim 27, wherein the intermediate controls comprise at least a set of slider bars.

30. An edited image according to claim 27, wherein the advanced controls comprise at least a set of editable curves.

31. An edited image according to claim 24, wherein the set of grouped editing controls comprises color editing controls, the color editing controls comprising at least one of color balance controls, saturation controls, hue controls, red-eye controls, color bit depth controls and white-balance controls.

32. An edited image according to claim 24, wherein the set of grouped editing controls comprises exposure editing controls, the exposure editing controls comprising at least one of low-light compensation controls, backlight controls and gain controls.

33. An edited image according to claim 24, wherein the method further comprises a step of storing the automatically adjusted image parameters as a retrievable setting.
